(19) United States
(12) Patent Application Publication
(10) Pub. No.: US 2006/0165022 A1
(43) Pub. Date: Jul. 27, 2006

(54) Circuit arrangement for operating transceivers on an antenna

(76) Inventors: Helmut Nast, Berlin (DE); Raimo Jacobi, Berlin (DE); Frank Heyder, Berlin (DE); Bernd Karlapp, Mellensee (DE)

Correspondence Address: KRIEGSMAN & KRIEGSMAN, 30 TURNPIKE ROAD, SUITE 9, SOUTHBOROUGH, MA, 01772, US

(21) Appl. No.: 10/549,046

(22) PCT Filed: Feb. 29, 2004
(86) PCT No.: PCT/DE04/00418

§ 371 Date: Sep. 12, 2005

(30) Foreign Application Priority Data
Mar. 11, 2003 (DE) 103 11 682.6

(51) Int. Cl. H04B 7/00

(52) U.S. Cl. 370/310

(57) ABSTRACT

The invention concerns a circuit arrangement for the operation of transmitting and receiving devices (T/R devices) at an antenna. A plurality of T/R devices can be operated for the most part without loss relative to the transmission and receiving powers and almost without mutual influencing of the signal branches of the devices by means of this circuit arrangement. For this purpose, circuit modules for compensation of attenuation (compensators) are disposed between the common antenna and each T/R device. All transmitting and receiving branches of the compensator are connected with the antenna by means of one interconnection unit. The transmitting branches are brought together via passive combiners with the interconnection of an isolator in each case, whereby the output power of their transmission amplifiers is increased in order to equilibrate the attenuation in the combiners. Incoming signals are distributed via splitters to all receiving branches of one frequency band of the compensator, whereby their attenuation is compensated for by an amplifier of the interconnection unit. The interconnection unit has a duplex switch for the separation of the signal paths for each frequency branch.

The invention concerns a circuit arrangement according to the preamble of the principal claim, as it is known from DE 199 13 064 C1. It concerns, in particular, a circuit arrangement for the simultaneous operation of several transmitting and receiving devices (T/R devices) at a common antenna serving for both receiving incoming signals as well as emitting transmitted signals. In this connection, the invention concerns a circuit arrangement in which a circuit module for the compensation (compensation unit) of the attenuation occurring in an HF cable connecting the antenna with the corresponding T/R device is disposed each time between the antenna and each T/R device.

In motor vehicles, for example, mobile wireless devices are connected with an external antenna on the vehicle by means of a hands-free voice system and an HF cable. This serves, on the one hand, for the purpose of distancing the driver from the radiation emitted by such a mobile wireless device during the transmitting operation. On the other hand, an improved receiving of incoming signals is achieved by the use of an external antenna with respect to the motor vehicle acting as a Faraday cage. Of course, undesired attenuations of the signal occur in the HF cable connecting the mobile wireless device or the hands-free voice system with the external antenna. Problems may therefore occur during transmitting and/or receiving operations in the mobile wireless device due to the narrow tolerances of performance specifications. In order to compensate for these, it is known to dispose units for the compensation of the attenuation that occurs between the mobile wireless device and the antenna; these so-called compensators act as compensation modules. In this case, special amplifier units are involved, which provide at least one transmitting branch with a power amplifier and at least one receiving branch with a receiving amplifier. Preferably, based on the detection of a transmission signal emitted by a connected mobile wireless device, the transmitting branch or receiving branch of such a compensator will be switched into the signal path in an alternating manner by means of appropriate circuit components. Optionally, such devices also have multi-band capacity. They then provide several transmitting and receiving branches, whereby transmission signals or received signals can be conducted to the transmitting or receiving branch designed for the corresponding frequency band, depending on the specific frequency band to which they belong, by means of so-called diplex filters. Such a circuit arrangement for compensation of attenuation is disclosed, for example, by DE 199 13 064 C1, which was indicated above.

In connection with the increasing extension of communications infrastructures, the continually increasing information need and the increasing utilization of telematics services, one development is attracting attention, according to which, for example, in motor vehicles, not only dual-band or multi-band-capable mobile wireless devices are simultaneously in operation, but also under certain circumstances, several transmitting and receiving devices are also operating. It is not desirable, however, of course, to provide on the motor vehicle an additional external antenna each time for this plurality of T/R devices. Therefore, transmitting and receiving branches of several such devices or peripheral devices belonging to them (for example, a hands-free voice system) are combined on a common antenna. As far as we know, this is done according to the prior art by means of so-called passive combiners and splitters, at which the transmission signals of the device are combined or the received signals specific to each of them are distributed. As long as the devices involve T/R devices which operate in the same frequency band, for example, the combining of the transmission signals to the common antenna is accomplished by a star-shaped structure of so-called λ/4 lines. These are lines which bring about a defined signal delay and thus a phase shift of a signal passing through them and which are connected together in such a way that undesired cross-talk of the transmission signal from a transmitting branch of one device to that of another device is largely prevented by a wave quenching. With respect to the combining, for example, of two GSM devices, an attenuation of approximately 30 dB is obtained between these devices in order to prevent them from influencing each other. This solution is still unsatisfactory, however, in individual cases relative to the transmitting operation. Also, a loss of at least 3 dB relative to the useful signal occurs with the described structure. That is, of the originally irradiated power of 2 W of a GSM 900 device, a maximal 1 W transmission power reaches the antenna. It is also a disadvantage that a structure with λ/4 lines is not suitable for the operation of so-called dual-band cell phones, which operate alternatively in the GSM 900 band or in the GSM 1800 band, since a λ/4 line of the GSM 900 band covering the wavelength of the signal, referred to the GSM 1800 band and its shorter wavelength, acts as a λ/2 line. The attenuation between the signal branches of two T/R devices guided to such a structure, which is based on the quenching of waves, therefore cannot be achieved simultaneously for the GSM 900 and the GSM 1800 operations by means of such an arrangement.

The object of the invention is to provide a circuit arrangement, which makes it possible to operate several T/R devices at a common antenna largely without losses with respect to the transmitting and receiving powers. A mutual influencing of the signal branches of several devices will also be avoided. In a preferred design, the circuit arrangement will also make possible the operation of several devices operating in different frequency bands.

The object is solved by a circuit arrangement with the features of the principal claim. Advantageous embodiments or enhancements of the invention are given by the subclaims.

In the proposed circuit arrangement, for the simultaneous operation of several T/R devices at a common antenna, circuit modules known in and of themselves are disposed for the compensation (compensation units—compensators) of the attenuation occurring in the HF cable connecting the antenna with each of the T/R devices. The compensator provides at least one transmitting branch with a power amplifier and at least one receiving branch with a receiving amplifier, which is alternately switched into the signal pathway, depending on whether the T/R device is receiving or transmitting. This is done on the device side, also in the known way, by means of a duplexer or HF two-way switch which is switched by a selection circuit or a detector circuit detecting a transmission signal of the respective T/R device. According to the invention, however, all transmitting and receiving branches of the compensation units or compensators are joined to the antenna by means of a special interconnection unit, in which, considered in the direction of signal flow, all transmission signals to be assigned to a frequency band and occurring at the outputs of transmission amplifiers of the compensators are combined at a duplex switch via one or more passive combining units (borrowed from the English, also denoted passive combiners) and are guided from this switch over optional additional filter units to the antenna. The incoming signals received at the antenna, which are to be introduced into the receiving branches of the compensators belonging to them according to the frequency band, are guided over the optionally provided additional filter units, the duplex switch, and by this, separately from the signal path of the transmission signals, are guided over an amplifier and a splitter to the inputs of the receiving amplifier. With reference to the transmitting branch, between the output of a transmission amplifier and a passive combiner of the interconnection unit connected directly to it, a blocking element (isolator) is disposed that will only let pass the transmission signals of this corresponding transmission amplifier. In addition, the output power of all transmission amplifiers of the compensators is increased corresponding to the attenuation of the transmission signal that occurs at the passive combiners subordinate to them. Due to the separate compensation of the attenuation occurring in the passive combiners in the respective transmission amplifiers of the compensation units and due to the use of isolators, intermodulations between the signal branches of the individual compensation units are prevented, i.e., the impinging of the outputs of the power or transmission amplifiers with the amplified transmission signals of another transmitting branch is securely prevented.

This measure is not necessary, however, relative to incoming received signals. Here, the attenuation which occurs at the splitter distributing the received signal passively to the receiving amplifiers of the compensators, is compensated for by a common amplifier of the interconnection unit effective for all receiving branches within one frequency band, and this amplifier is connected upstream to the splitter. The circuit arrangement is capable of duplexing due to the illustrated construction, and in fact, this duplexing is independent of whether the same is true for the T/R devices themselves that operate therein. It is hereby possible that one or more T/R devices are transmitting signals, while simultaneously other T/R devices are receiving signals, via the same circuit arrangement.

Corresponding to a preferred enhancement of the circuit arrangement according to the invention, the compensators have several transmitting and receiving branches on the device side, thus on the side of the T/R devices, connected via a diplexer, for amplifying signals of different frequency bands. The interconnection unit is formed in a corresponding manner, whereby the transmission signals amplified by the compensators and the received signals guided to them are conducted over different frequency branches of the interconnection unit according to their frequency band. This measure involves a frequency band switch, a so-called diplexer for at least one of the filter units which is subordinate to the one or more duplex switches of the interconnection unit in the direction of the antenna, according to this configuration. By means of the diplexer, transmission signals that are conducted over different frequency branches of the interconnection unit are combined prior to conducting them further to the antenna, and, in an analogous way, incoming signals received are separated from one another. Also, the components of the interconnection unit named in the basic presentation of the circuit arrangement according to the invention are present for each frequency branch in this embodiment. Accordingly, each frequency branch of the interconnection unit consists of at least one or more passive combiners, a duplex switch, a splitter, as well as an amplifier connected upstream to the splitter. Basically, it is also conceivable to replace the diplexer by an externally controlled switch-over unit (for example, by correspondingly designed, i.e., switchable mobile wireless devices). Of course, the limitation arises here that T/R devices operating in different frequency bands can be basically operated with the circuit arrangement, but simultaneously each of the devices always operates only in one frequency band.

According to an embodiment suitable in practice, the interconnection unit has two frequency branches, wherein these are preferably designed so that the circuit arrangement is suitable for the operation of several mobile wireless devices to be used in networks with different frequency bands. With respect to the GSM standard used predominantly today for mobile wireless transmission, thus for example, mobile wireless devices (cell phones or the like) can be operated by means of the circuit arrangement via an antenna which operates alternatively in the GSM 900 network and/or in the GSM 1800 network.

Preferably, the circuit arrangement and optionally also its units or modules named above, thus, in particular, the compensators and the interconnection unit are constructed modularly. In such a modular design, isolators are integrated between the outputs of the power amplifier and the passive combiners, preferably into the module that makes up the interconnection unit, wherein an isolator is connected upstream to each input of a passive combiner for the transmission signal.

In addition, an advantageous embodiment of the circuit arrangement is given by the fact that the power amplifiers of the compensation units are realized by means of basic amplifier modules that can be obtained commercially. With respect to the requirements of the GSM standard with a transmission power of 2 W in the GSM 900 network or 1 W in the GSM 1800 network and the requirement for an increase in output power for the compensation of the attenuation occurring in one or more passive combiners, the use of basic modules with an output power of 4 W or 2 W, respectively, is taken into consideration. Insofar as higher output powers are necessary for the transmission amplifiers, due to the number of T/R devices provided maximally for the operation of the circuit arrangement and the related concrete design of the interconnection unit, corresponding output powers can be attained by suitable interconnection of such basic modules. In this case, the transmission amplifiers for a frequency band are interconnected by so-called 90° hybrids to the outputs and inputs, each time within one compensation unit, according to one possible configuration of the invention.

With respect to the number of T/R devices maximally operating on one antenna by means of the circuit arrangement, according to an embodiment of the invention which is suitable in practice, a specifically graded increase in the number of components which is necessary for this purpose, in particular, the number of passive combiners, is provided. The circuit arrangement is accordingly always designed for simultaneous operation, with respect to number, of a power (combination power) corresponding to 2 T/R devices (combination maximum). This means that the circuit arrangement is designed for the simultaneous operation of 2, 4, 8, etc. T/R devices. Thus, for example, if 6 T/R devices are to be operated by means of an embodiment of the circuit arrangement according to the invention that is oriented to such a gradation, an embodiment making possible the operation of a maximum of 8 T/R devices would be used for this purpose. Each frequency branch of the interconnection unit in the signal path for the transmission signals thus has a number of passive combiners that is decreased by 1 when compared to the combination maximum (thus for the operation of a maximum of 8 T/R devices=7 passive combiners), which are wired in circuit with one another in a number of cascade steps corresponding to the combination power (thus, again with reference to the example of a maximum of 8 T/R devices to be operated, 3 cascade steps −2³=8), while the splitters of the respective signal path for the signals received divide these signals into a number of signal paths corresponding to the combination maximum. Based on the larger number of passive combiners (more precisely, because of this and for cascading in the example of embodiment), the attenuation of the transmission power of a T/R device that occurs on them is necessarily increased. Consequently, the output power of the power amplifiers of the compensators must be adequately increased, i.e, preferably so that for each combiner or cascade step, the output power of each power amplifier of a compensation unit is doubled with reference to the power of a transmission signal of a T/R device conducted over the respective power amplifier.

In the case of an additional filter unit disposed, as discussed above, optionally between a duplex switch—or in the case of a multi-band-capable design between the diplexer—of the interconnection unit and the antenna, this involves, for example, a harmonic filter. Preferably, an ESD protective unit, which protects the remaining circuit components against electrostatic discharge, is also disposed between a duplex switch or a diplexer and the antenna. With respect to a modular construction of the circuit arrangement according to the invention, the surface* filter and/or the ESD protective unit are preferably components on the antenna side of a module that forms the interconnection unit.
*sic; harmonic?—Trans. note.

The invention will be explained once more in more detail below on the basis of embodiment examples. In the appended drawings:

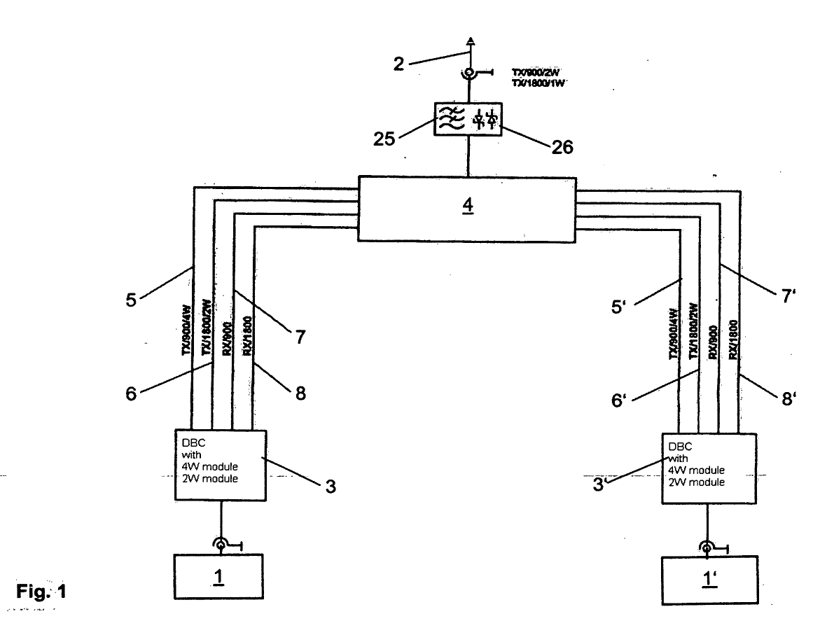

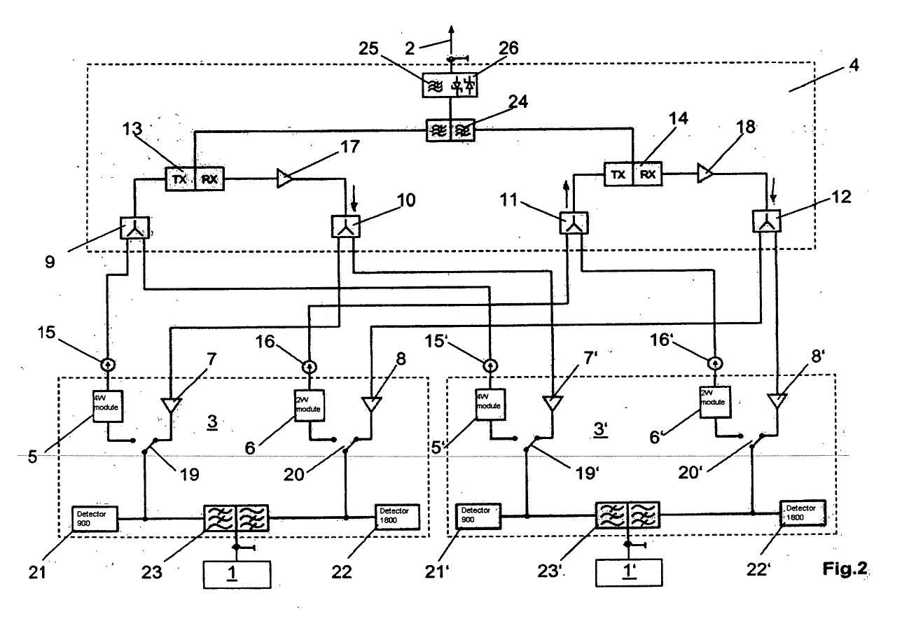

FIG. 1: A rough block diagram of the circuit arrangement according to the invention FIG. 2: A somewhat more detailed block diagram of the circuit arrangement according to FIG. 1.

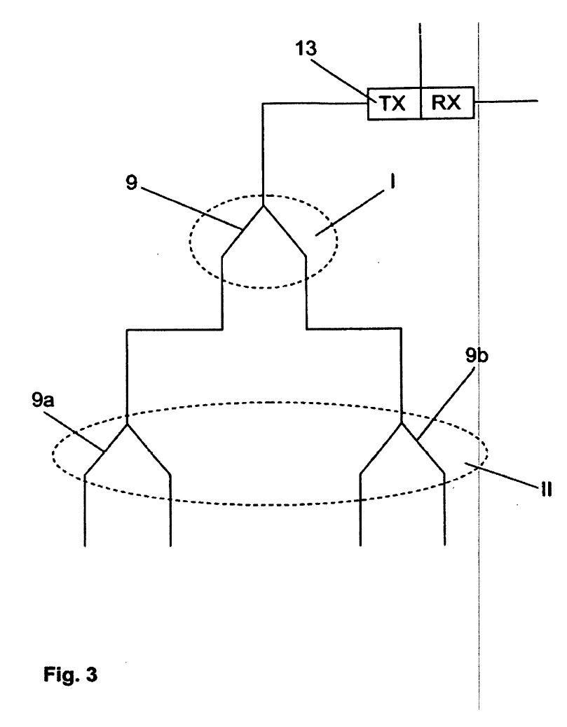

FIG. 3: An excerpt from the circuit arrangement according to FIG. 2 in an embodiment for the operation of four transmitting and receiving devices

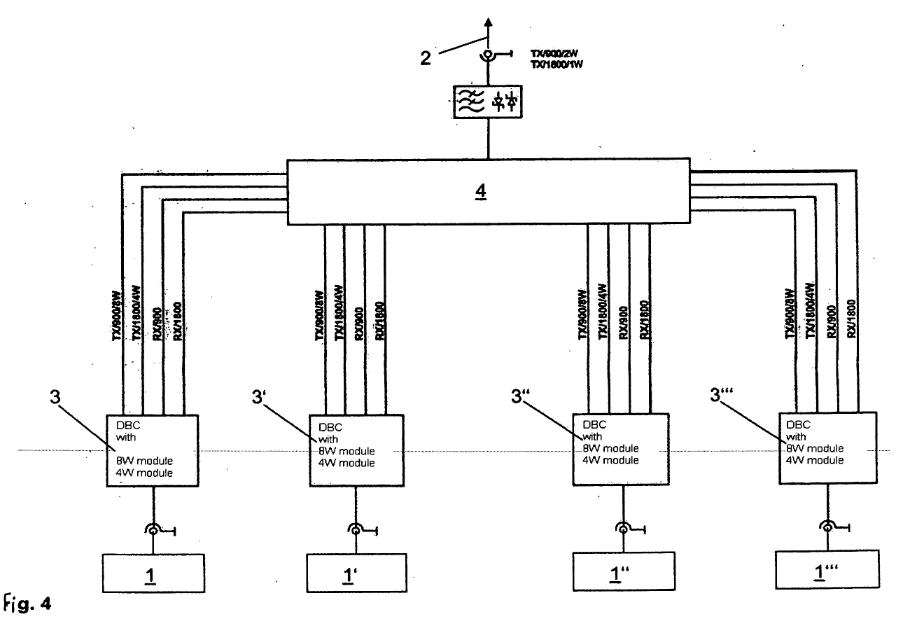

FIG. 4: The block diagram corresponding to FIG. 1 in an embodiment for the operation of four transmitting and receiving devices

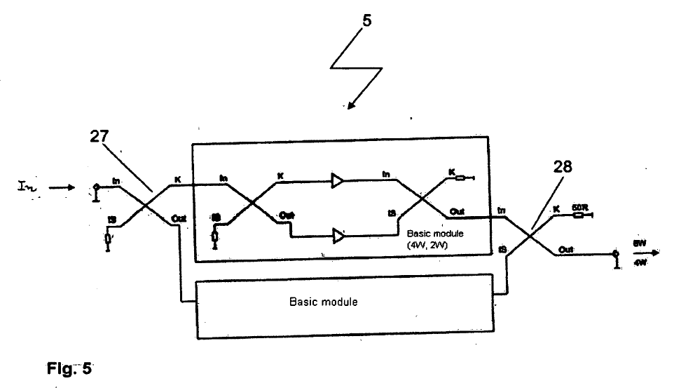

FIG. 5: The interconnection of the transmitting branches of two basic modules for compensators in order to obtain an increased total transmission power

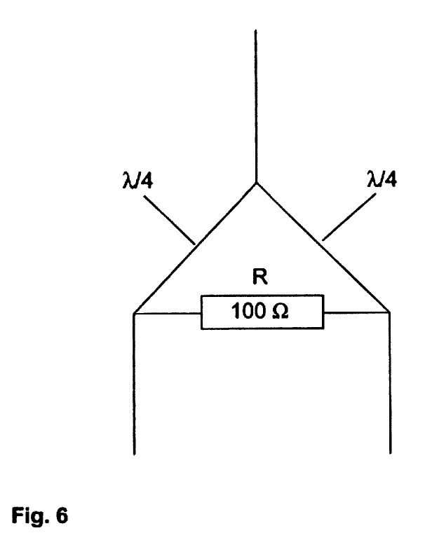

FIG. 6: The combination of signal paths by means of λ/4 lines according to the prior art.

FIG. 1 shows a rough block diagram of the circuit arrangement according to the invention. It involves an example of embodiment for the common operation of 2 T/R devices 1, 1′ at an antenna 2. First, as is known from the prior art, a compensation unit 3, 3′ (compensator) for the compensation of the attenuation occurring in the HF cable connecting the T/R device 1, 1′ with the antenna 2 is provided between each T/R device 1, 1′ and the antenna 2. According to the example shown, it involves a dual-band-capable compensator 3, 3′ which makes possible operation both in the GSM 900 and GSM 1800 frequency bands. All transmitting and receiving branches 5, 5′, 6, 6′, 7, 7′, 8, 8′ of the two compensators 3, 3′ are guided to an interconnection unit 4, a more detailed explanation of which will be made on the basis of FIG. 2.

FIG. 2 shows the circuit arrangement according to FIG. 1 also as a block diagram, but in a somewhat more detailed representation. In this representation, the components of compensators 3, 3′ are also given in a somewhat more detailed manner. It can be seen that the two compensators 3, 3′ involve so-called dual-band compensators, which make possible the operation of a dual-band cell phone or the selective operation of a GSM 900 or GSM 1800 cell phone 1, 1′, respectively. For this purpose, the transmitted and received signals on the device side are conducted by means of a diplexer 23, 23′. In transmission mode the diplexer 23, 23′ assures that a GSM 900 transmission signal is conducted on the 4-Watt amplifier module of the compensator 3, 3′ and a GSM 1800 signal is conducted on its 2-Watt module. HF two-way switches 19, 19′, 20, 20′ are disposed in each case in the leads of the amplifier modules. These are switched by means of detectors 21, 21′, 22, 22′ when a transmission signal is present on transmitting branch 5, 5′, 6, 6′. In the reproduced representation, all HF two-way switches 19, 19′, 20, 20′ of compensators 3, 3′ are connected in such a way that their receiving branches 7, 7′, 8, 8′ are switched into the signal path. This corresponds to the base state of the circuit arrangement, which is thus ready for receiving incoming signals, independently of whether these are GSM 900 or GSM 1800 signals. The switching to the transmitting branch 5, 5′, 6, 6′, as already shown, is conducted each time always only upon detection of a transmission signal. As soon as the transmission signal fails to appear, the two-way switch 19, 19′, 20, 20′ belonging thereto again passes into the base state. The respective transmitting branches 5, 5′, 6, 6′ of the two compensators 3, 3′, namely the transmitting branches 5, 5′ for the GSM 900 frequency band, on the one hand, and the transmitting branches 6, 6′ for the GSM 1800 frequency band, on the other hand, are each conducted on the output side to a passive combiner 9, 11. As is known from the prior art, only the combining of the signal branches is produced in this case. In order to compensate for the attenuation here, the output powers of the power amplifier are correspondingly increased in the transmitting branches 5, 5′, 6, 6′ of the compensators 3, 3′, as can be recognized. The output power of the transmission amplifier for the GSM 900 band consequently amounts to 4 W instead of the actually required 2 W and that of the GSM 1800 branch is 2 W instead of the required 1 W. In order to prevent crosstalk between the transmitting branches 5, 5′, 6, 6′ of the same frequency band of the two compensators 3, 3′, a special blocking filter 15, 15′, 16, 16′, a so-called isolator, is disposed between the output of a transmission amplifier and the passive combiner 9, 11, respectively, connected to it each time. Corresponding to an already mentioned embodiment of the invention, this isolator can be a component of interconnection unit 4, or, as in the example shown, can be disposed each time directly behind the output of a power amplifier. The transmission signals at the passive combiner 9, 11 are combined and from here are guided [via] additional filter units 24, 25 to antenna 2 by means of the duplex switches 13, 14, which make possible the duplex capability of the arrangement. In the reverse direction, incoming signals received at antenna 2 are guided via filter units 25, 24 to the duplex switches 13, 14, and are distributed from these via a splitter 10, 12 to the receiving amplifier of the compensators 3, 3′. An incoming signal that is received thus is applied to the two HF plug connectors or connectors of the circuit arrangement provided for connection to the T/R devices 1, 1′, independently of frequency band, as long as one of the two T/R devices (cell phones) 1 or 1′ shown in the drawing is not in transmission mode. Of course, an attenuation of the signal is also caused by the splitters 10, 12 in the receiving path. This can be compensated for, however, by an amplifier 17, 18 common to the two compensators 3, 3′, unlike in the transmission path 5, 5′, 6, 6′. As can be recognized in the drawing, these amplifiers are connected in front of the respective splitter 10, 12.

The circuit arrangement according to the invention for the operation of two T/R devices 1, 1′, which is shown in FIGS. 1 and 2, can also be modified for the operation of more than two T/R devices 1, 1′, 1″, 1′″ while maintaining the basic principle. This possibility of a modification of the circuit arrangement according to the invention is illustrated as indicated by FIG. 3 relative to a use for the operation of more than two T/R devices. As given in the claims and in the presentation of the solution according to the invention, the transmitting branches of the compensators 3, 3′, 3″, 3′″ are combined by means of one or more passive combiners. The presentation of FIG. 3 thus concerns an excerpt of the circuit arrangement according to FIG. 2, and stated more precisely, its design in the region of the combiners 9, 9a, 9b. It concerns a configuration of the circuit arrangement according to the invention for operation of a maximum of four T/R devices 1, 1′, 1″, 1″ in a preferred variant. According to this configuration, the transmitting branches of the compensators are combined in pairs each time.

This is done by means of the cascading of several passive combiners 9, 9a, 9b in several planes. It is clear here that another plane of combiners is made necessary with each doubling of the maximum number of T/R devices 1, 1′, 1″, 1′″ to be operated according to this variant and the number of combiners themselves increases correspondingly. It can be seen at the same time that these embodiment variants that are presented lead to a power series of 2 corresponding grades with respect to the maximum number of T/R devices 1, 1′, 1″, 1′″ to be operated. This means also that the desired operation of 6 T/R devices, for example, requires an embodiment variant of the circuit arrangement according to the invention that will allow a maximum of 8 T/R devices to be operated. Therefore, the number of necessary cascades 1, 11 of passive combiners 9, 9a, 9b corresponds to the respective power of 2. This means that the operation of two, i.e., 21 T/R devices requires one passive combiner per frequency branch, that of a maximum of 4 T/R devices, on the other hand, 2 cascades with a total of 3 passive combiners. In this context, the block diagram according to FIG. 1 is presented in FIG. 4 once more for an embodiment of the circuit arrangement for the operation of four T/R devices 1, 1′, 1″, 1′″.

As already mentioned, with an increasing number of T/R devices 1, 1″ to be operated, the necessary transmission power of the power amplifier increases in the transmitting branches 5, 5′, 6, 6′ of the compensators 3, 3′. This is associated with the increasing number of necessary combiners 9, 9a, 9b, 11 and the attenuation that increases in this way in this circuit part. With respect to the attenuation of an assumed at least 3 dB per combiner step, a power of 4 W is required therefore for the interconnection of two compensators 3, 3′ to the outputs of their power amplifiers in the GSM 900 band and a power of 2 W is required for the GSM 1800 band. Consequently, the necessary power for a maximum number of 4 T/R devices 1, 1′, 1, 1″ increases to 8 W in the GSM 900 band or 4 W in the GSM 1800 band, respectively. According to a preferred embodiment of the invention with a modular design of its components, standard modules with an output power of 2 W are used for providing this amplifier power. In order to obtain the optionally necessary higher power of 4 W, 8 W or even 16 W, following these considerations, a corresponding number of these standard modules are interconnected. This is done by means of so-called 90° hybrids 27, 28. This point is illustrated by FIG. 5, which shows a transmitting branch 5 with a power amplifier consisting of base modules.

With respect to the star-shaped circuitry of λ/4 lines, which was mentioned above several times, this procedure known from the prior art will be clarified once more by FIG. 6. Accordingly, for example, two transmitting branches are combined so that they are interconnected via two λ/4 lines and are connected via a resistor R of 100 ohms, for example. In this way, the direct wave is transfered via the resistor between the two branches and a wave rotated by 180° to this is transferred over the two λ/4 lines acting as phase shifters. This leads to a cancellation of the wave each time at the connection points of the transmitting branches and thus to an isolation of the two branches, so that, optionally, signals crosstalking from one transmitting branch to the other are attenuated by approximately 30 dB. The existing deficiencies in this purely passively acting arrangement have already been explained and are overcome by the circuit arrangement according to the invention.

### LIST OF REFERENCE NUMBERS USED

1, 1′, 1″, 1′″ Transmitting and receiving device (T/R device)
2 Antenna
3, 3′, 3″, 3′″ Compensation unit (compensator)
4 Interconnection unit
5, 5′ Transmitting branch with power amplifier
6, 6′ Transmitting branch with power amplifier
7, 7′ Receiving branch with receiving amplifier
8, 8′ Receiving branch with receiving amplifier
9, 9a, 9b Passive combiners (combiners)
10 Splitter
11 Passive combiners (combiners)
12 Splitter
13, 14 Duplex switch
15, 15′ Isolator
16, 16′ Isolator
17, 18 Amplifier
19, 19′ HF Two-way switch
20, 20′ HF Two-way switch
21, 21′ Detector circuit
22, 22′ Detector circuit
23, 23′ Diplexer
24 Diplexer
25 Harmonic filter
26 ESD Protective unit
27, 28 90° Hybrid

1. A circuit arrangement for the simultaneous operation of several transmitting and receiving devices (T/R devices) at a common antenna serving both for the receiving of incoming signals as well as for the emission of transmitted signals,
in which between the antenna and each T/R device a compensation unit is disposed each time for the compensation of the attenuation occurring in an HF cable connecting the antenna with the corresponding T/R device,
which provides at least one transmitting branch with a power amplifier and at least one receiving branch with a receiving amplifier, whereby depending on whether the T/R device is receiving or is transmitting signals, these branches are connected on the device side alternately in the signal path by means of a duplexer or HF two-way switch switched by a selection circuit or a detector circuit detecting a transmission signal of the relevant T/R device,
is hereby characterized in that on the antenna side, all transmitting and receiving branches of the compensation units are connected with antenna by means of an interconnection unit, in which, considered in the direction of signal flow, all transmission signals that arise at the outputs of transmission amplifiers in transmitting branches of the compensation units and are to be assigned to one frequency band are interconnected via one or more passive combiners to a duplex switch and are conducted from this switch to antenna and that the received signals arriving at antenna and which are to be introduced into the receiving branches of the compensation units that belong to the respective frequency band, separated via the duplex switches from the signal path of the transmission signals, are guided via an amplifier and a splitter to the inputs of the receiving amplifier in the receiving branches,
wherein a blocking element that allows to pass only the transmission signals of the corresponding transmission amplifier is disposed each time between the output of a transmission amplifier and a passive combiner directly connected with it and the output power of all transmission amplifiers of the compensation units corresponding to the attenuation of the transmission signal that occurs at the passive combiners is increased,
and wherein the attenuation occurring at the splitter distributing the received signal passively to the receiving amplifier of compensation units is compensated for by the amplifiers of the interconnection unit connected in front of it.

2. The circuit arrangement according to claim 1, further characterized in that additional filter units are disposed between the duplex switches and the antenna.

3. The circuit arrangement according to claim 1, further characterized in that the compensation units have several transmitting branches connected in a circuit via a diplexer and receiving branches for the amplification of signals of different frequency bands, whereby the transmission signals amplified by them and the received signals introduced into them are conducted over different frequency branches of the interconnection unit according to their frequency band and at least one of the additional filter units involves a frequency band switch (diplexer), at which transmission signals conducted via different frequency branches of the interconnection unit are brought together, or signals that are received are separated from one another, whereby each frequency branch of the interconnection unit consists of at least one or more passive combiners, a duplex switch a splitter as well as an amplifier connected in front of the splitter.

4. The circuit arrangement according to claim 3, further characterized in that the interconnection unit has two frequency branches.

5. The circuit arrangement according to claim 4, further characterized in that it is designed for the operation of several mobile wireless devices operating selectively in the GSM 900 network and/or in the GSM 1800 network.

6. The circuit arrangement according to claim 1, further characterized in that the circuit arrangement and optionally its units are constructed as modules.

7. The circuit arrangement according to claim 6, further characterized in that with respect to a modular construction of the circuit arrangement, the isolators are components of the interconnection unit, wherein an isolator is connected in front of each input of a passive combiner for the transmission signal.

8. The circuit arrangement according to claim 6, further characterized in that the power amplifiers of the compensation units are realized by amplifier basic modules, which, optionally, are interconnected at the outputs and inputs via 90° hybrids for obtaining the output power necessary for the compensation of the attenuation in the HF cable and the passive combiners, each time within a compensation unit and relative to the transmitting branch for one frequency band.

9. The circuit arrangement according to claim 1, further characterized in that it is designed for the simultaneous operation of T/R devices (combination maximum) corresponding to a power (combination power) of 2 with respect to number, wherein each frequency branch of the interconnection unit has a number of passive combiners decreased by 1 when compared to the combination maximum in the signal pathway for the transmission signals, which combiners are wired in circuit with one another in a number of cascade steps corresponding to the combination power, while the splitters of the respective signal path for the signals received divide these into a number of signal paths corresponding to the combination maximum and the number of compensation units corresponds to the combination maximum and wherein for each cascade step, the output power of each power amplifier of a compensation unit is doubled relative to the power of a transmission signal of a T/R device conducted over the respective power amplifier.

10. The circuit arrangement according to claim 1, further characterized in that a harmonic filter is disposed between a duplex switch or a diplexer of the interconnection unit and the antenna.

11. The circuit arrangement according to claim 1, further characterized in that an ESD protective unit protecting the remaining circuit components against electrostatic discharge is disposed between a duplex switch or a diplexer of the interconnection unit and the antenna.

12. The circuit arrangement according to claim 10, further characterized in that a harmonic filter and/or an ESD protective unit represent components of the interconnection unit disposed on the antenna side relative to a modular construction of the circuit arrangement.

13. The circuit arrangement according to claim 11, further characterized in that a harmonic filter and/or an ESD protective unit represent components of the interconnection unit disposed on the antenna side relative to a modular construction of the circuit arrangement.
